(19) United States
(12) Patent Application Publication
(10) Pub. No.: US 2007/0056635 A1
(43) Pub. Date: Mar. 15, 2007

(54) Fluid regulator

(76) Inventors: Michael D. Elberson, Elm Grove, WI (US); Matthew Yoss, Menomonee Falls, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/517,795

(22) Filed: Sep. 8, 2006

Related U.S. Application Data
(60) Provisional application No. 60/716,826, filed on Sep. 14, 2005.

(51) Int. Cl. G05D 16/06

(52) U.S. Cl. 137/505.36

(57) ABSTRACT

A fluid regulator having a body that encloses a chamber includes a gasket, a valve seat, and a valve stem. A fluid inlet and a fluid outlet are connected to the chamber and the gasket fluidly separates a portion of the chamber from a fluid path between the fluid inlet and the fluid outlet. The valve seat is disposed in the fluid path and the valve stem extends through the gasket and directly engages the valve seat to selectively isolate an inlet side of the fluid path from an outlet side of the fluid path. Such a construction provides a fluid regulator with a reduced number of parts exposed to the regulated fluid flow.

This application claims priority to U.S. Provisional Application Ser. No. 60/716,826, filed on Sep. 14, 2005, the entirety of which is incorporated herein.

### FIELD OF THE INVENTION

The present invention relates to a fluid regulator, and in particular, to a fluid flow regulator for use in industrial compressed air systems such as in automated paint systems having a fluid valve that is pulled rather than pushed to a closed position.

### BACKGROUND OF THE RELATED ART

In spray paint operations, a paint fluid, commonly in the form of a liquid or a relatively fine powder, is mixed with compressed air to atomize the paint particles and transfer the atomized paint particles onto the surface of an item being painted. Frequently, a paint gun is fluidly connected to a paint source and an air source and mixes the two materials proximate a paint location. Alternatively, many paint guns include a paint container that is physically supported by the paint gun. During most painting operations, it is very important to maintain a clean paint supply in order to ensure a quality finish. The paint fluid is frequently formed from a mixture of resins and colored particulates or flakes. The paint fluid is generally delivered to a mixing point through a series of pipes, tubes, or hoses. Preferably, this fluid path is relatively smooth or free of steps of discontinuities where the resin or color particulates may collect and form an undesirable particulate or resin ball. Understandably, any collection of particulates or resin, whether solid or pliable, introduced into the fluid paint flow can detrimentally affect operation of the paint gun or quality of the paint finish.

One commonly used spray paint gun, commonly referred to as a high volume low pressure (HVLP) spray gun, generates high volumes of low-pressure air which transfers the paint particles to the surface of the article being painted with relatively low velocity. The high volume low velocity transfer of paint to the work piece reduces overspray generated during the painting process and thereby improves the paint to part transfer ratio. In such systems, a fluid regulator regulates the flow of fluid between a high-pressure port and a low-pressure port of the paint gun. There are various types of regulators that are commonly used to provide this fluid flow pressure control.

One common type of such a fluid regulator is generally known as a diaphragm-type regulator. This regulator typically comprises a valve body, a diaphragm, a poppet valve, and a spring. When fluid pressure at a low pressure port of the valve body is lower than a predetermined air pressure or manual spring pressure, a mechanical force operating on the underside of the diaphragm head lifts the diaphragm operated stem valve off the high pressure inlet port to provide fluid flow between the inlet port and the outlet port. Such a construction directs the fluid flow across and through a secondary valve closing spring during fluid flow through the regulator. The fluid flow across the secondary closing spring dislodges particulates that may be attached to the closing spring. Furthermore, the movement of the closing spring tends to loosen any particulates that may have been stuck to the closing spring from a previous use. These particulates are particularly problematic in paint spraying applications. As mentioned above, the particulates or collection of resins tend to plug a nozzle of the paint gun or, if allowed to pass entirely through the paint gun, result in blemishes in the finish of the product. Accordingly, it is desired to provide a fluid regulator having a reduced number of parts exposed to the fluid flow through the regulator.

Another drawback of known regulator constructions is the connection of the regulator to the associated operating system. For example, connecting a fluid regulator to a paint spraying system commonly requires connecting the regulator to the paint sprayer either through utilization of a specialized fluid fitting or fasteners tailored to engage the paint sprayer and the body of the fluid regulator. Understandably, requiring a fluid connector adapted to engage the paint sprayer and the fluid regulator limits the functionality and adaptability of the paint sprayer and utilization of the fluid regulator for other applications or implementation with other paint sprayers. Likewise, connecting the fluid filter to the paint sprayer with specialized fasteners commonly requires associating several fasteners with corresponding openings in the paint gun and fluid regulator. Understandably, either of these methods of fastening a plurality of fluid lines to a regulator and mounting the regulator to an underlying tool can be a time consuming and trying process. Accordingly, it would also be desirable to provide a fluid regulator that can be simply and efficiently connected to an underlying tool or implement.

### SUMMARY OF THE INVENTION

The present invention is directed to a fluid regulator that solves the aforementioned problems. The fluid regulator has a body that encloses a chamber and includes a gasket, a valve seat, and a valve stem. A fluid inlet and a fluid outlet are connected to the chamber and the gasket fluidly separates a portion of the chamber from a fluid path between the fluid inlet and the fluid outlet. The valve seat is disposed in the fluid path and the valve stem extends through the gasket and directly engages the valve seat to selectively isolate an inlet side of the fluid path from an outlet side of the fluid path. Such a construction provides a fluid regulator with a reduced number of parts exposed to the fluid flow.

Therefore, in accordance with one aspect of the present invention, a fluid regulator having a regulator body, a valve seat, and a movable valve member is disclosed. The valve seat is positioned in a cavity defined by the regulator body. The movable valve member includes a poppet and a ball portion formed at an end thereof. An inlet port and an outlet port are formed through the regulator body and are fluidly separable by the valve seat and the movable valve member. A diaphragm divides the cavity into a first portion and a second portion such that the first portion has the valve seat and the movable valve member and the second portion is fluidly isolated from the first portion. A biasing means is connected to the poppet and is positioned within the second portion of the cavity for moving the movable valve member.

According to another aspect of the present invention, a fluid regulator having a valve body constructed to be pulled closed is disclosed. The fluid regulator includes a diaphragm disposed in a housing and configured to divide an interior of the housing into a first region and a second region. A fluid inlet and a fluid outlet are connected to the first region. A valve seat is disposed in the first region between the fluid inlet and the fluid outlet. A valve body extends through the diaphragm and is constructed to sealingly engage the valve seat to isolate the fluid inlet and the fluid outlet when the valve body is engaged with the valve seat. A spring is connected to the valve seat and configured to pull the valve body into engagement with the valve seat.

Another aspect of the present invention discloses a regulator having a valve stem that directly engages a valve seat. The regulator includes a body that encloses a chamber and has a fluid inlet and a fluid outlet. A gasket fluidly separates a portion of the chamber from a fluid path between the fluid inlet and the fluid outlet. A valve seat is disposed in the fluid path and a valve stem extends through the gasket and is constructed to directly engage the valve seat to selectively isolate an inlet side of the fluid path from an outlet side of the fluid path.

Various other features, aspects, and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a perspective view of a fluid regulator according to the present invention.

FIG. 2 is a cross-sectional elevational view of the fluid regulator taken along line 2-2 shown in FIG. 1 with the fluid valve in a closed position.

FIG. 3 is a view similar to FIG. 2 with the fluid valve in an open position.

### DETAILED DESCRIPTION OF THE PREFERRED EMBODIMENT

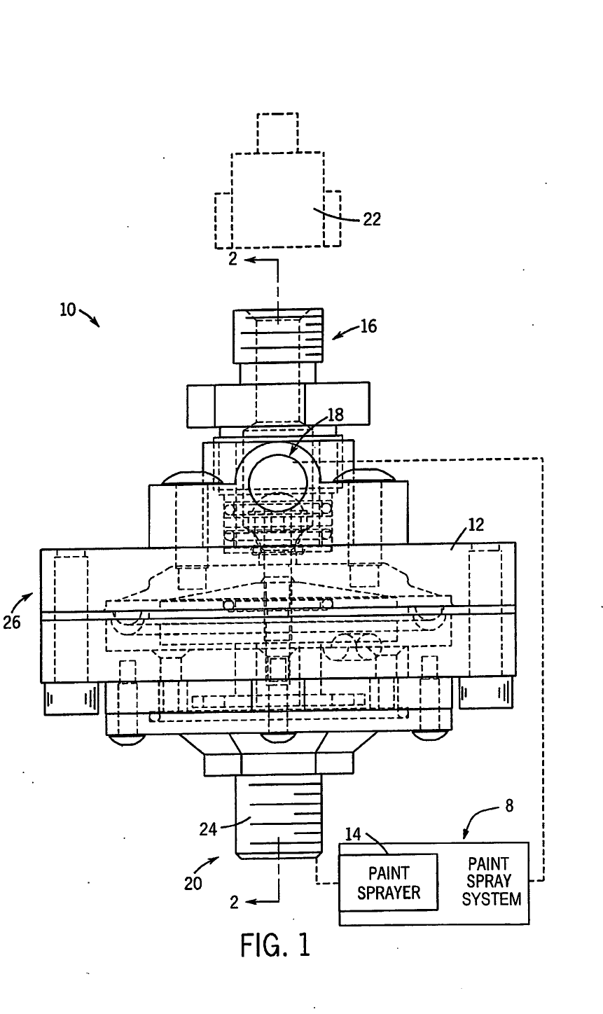

FIG. 1 shows a regulator or fluid regulator 10 according to the present invention. Fluid regulator 10 includes a body, a regulator body, or a housing 12 constructed to be connected to a paint spraying system 8 having a paint sprayer 14 constructed to generate an atomized paint spray. Housing 12 includes a paint or fluid inlet 16, a paint or fluid outlet 18, and a signal input or inlet 20. Fluid inlet 16 is constructed to engage a coupler or quick connector 22 fluidly connected to a paint source. Fluid outlet 18 is fluidly connected to paint sprayer 14 to selectively communicate fluid, i.e. paint, through fluid regulator 10. Housing 12 includes a threaded portion 24 for efficiently mounting fluid regulator 10 to paint spray system 8. Although threaded portion 24 is shown as being formed about signal inlet 20, it is appreciated that the threaded portion 24 could be formed about any of an exterior surface 26 of fluid regulator 10. Such a construction allows fluid regulator 10 to be attached to paint spraying system 8 in a simple and efficient manner.

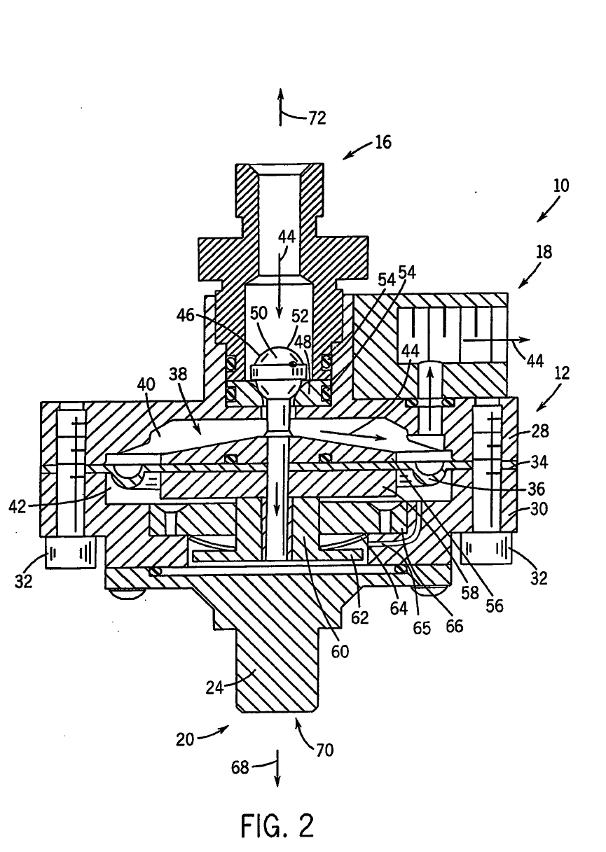

Referring to FIG. 2, housing 12 includes a first portion 28 and a second portion 30 secured together by a plurality of fasteners 32. A perimeter 34 of a seal, gasket, or diaphragm 36 is sealingly disposed between first portion 28 and second portion 30 of housing 12. A chamber or cavity 38 is enclosed by housing 12 and divided into a first section or portion 40 and a second section or portion 42 by diaphragm 36. First portion 40 of cavity 38 is fluidly isolated from second portion 42 of cavity 38 by diaphragm 36.

A fluid path, indicated by arrow 44, extends through fluid regulator 10 between fluid inlet 16 and fluid outlet 18 and travels through first portion 40 of cavity 38. A valve body, a valve stem, or a moveable valve member 46 operatively engages a valve seat 48 to selectively interfere with or interrupt the fluid flow along fluid path 44. Moveable valve member 46 includes a ball portion 50 formed proximate an end 52 of moveable valve member 46. Ball portion 50 is constructed to sealingly engage valve seat 48 when the moveable valve member 46 is engaged with the valve seat 48. Fluid inlet 16 is threadingly connected to housing 12 and is constructed to secure valve seat 48 between fluid inlet 16 and housing 12. A seal 54 is disposed between housing 12 and each of fluid inlet 16 and valve seat 48. Seals 54 ensure fluid passed through fluid inlet 16 is only allowed to pass through fluid regulator 10 via the operative association of movable valve member 46 and valve seat 48.

A pair of backer plates 56, 58 is attached to diaphragm 36 and attach moveable valve member 46 to the diaphragm. A poppet or valve bracket 60 extends from backer plate 58 and is also constructed to engage moveable valve member 46. Valve bracket 60 includes a flange 62 which extends generally radially outwardly from moveable valve member 46. A biasing means, such as a spring 64, is disposed between flange 62 and a spring plate 66. Spring plate 66 is attached to second portion 30 of housing 12 to secure spring 64 to the housing 12. It is appreciated biasing means other than a spring are envisioned and within the scope of the claims. For example, biasing means 64 could be magnetic in nature wherein flange 62 is repelled by spring plate 66 to bias the movable valve member to a closed orientation. Other biasing means such as alternate gas flows or other mechanical means are also envisioned and within the scope of the claims.

Spring 64 biases moveable valve member 46 in a direction, indicated by arrow 68 such that moveable valve member 46 sealingly engages valve seat 48. An input signal, indicated by arrow 70, communicated to signal inlet 20, overcomes bias 68 of spring 64, and passes through a passage 65 to deflect valve bracket 60, backer plates 56, 58, diaphragm 36, and moveable valve member 46 in a direction, indicated by arrow 72 to disengage moveable valve member 46 from valve seat 48. Such operation fluidly connects fluid inlet 16 and fluid outlet 18 via first portion 40 of cavity 38.

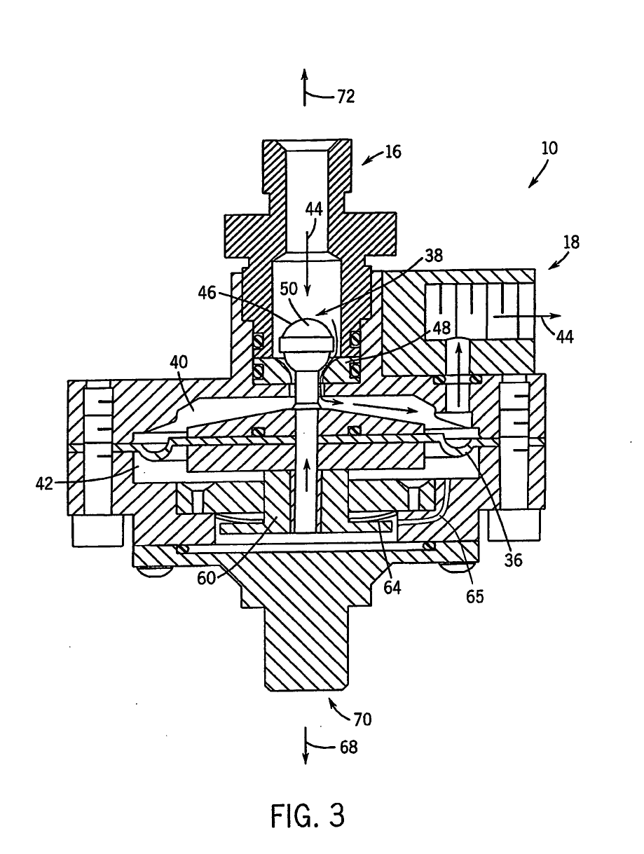

As shown in FIG. 3, introduction of input signal 70 translates moveable valve member 46 relative to valve seat 48 thereby allowing fluid path 44 to extend uninterruptingly from fluid inlet 16 to fluid outlet 18. Diaphragm 36 fluidly isolates second portion 42 of cavity 38 from fluid flowing through fluid path 44 of fluid regulator 10. Accordingly, even though fluid path 44 is free of springs or other biasing means that would at least partially interrupt the fluid flow through fluid path 44, fluid regulator 10 provides a selectively severable fluid path. Suspension or termination of input signal 70 allows spring 64 to pull ball portion 50 of moveable valve member 46 into engagement with valve seat 48, thereby covering or otherwise closing fluid path 44 to prevent fluid communication between fluid inlet 16 and fluid outlet 18. Spring 64 is constructed to overcome the mechanical hysteresis of diaphragm 36 to severe fluid path 44 with the suspension of input signal 70. Accordingly, fluid regulator 10 provides a fluid regulator having a fluid path with a reduced number of parts subjected to fluid flow. Such a construction provides a fluid regulator that is simple to maintain and efficient to operate and connect to associated systems. Furthermore, fluid regulator 10 reduces the potential of polluting the fluid flow with residual particulates by reducing the number of structures that interferes with the fluid path through the regulator.

Therefore, one embodiment of the invention is a fluid regulator having a regulator body, a valve seat, and a movable valve member. The valve seat is positioned in a cavity defined by the regulator body. The movable valve member includes a poppet and a ball portion formed at an end thereof. An inlet port and an outlet port are formed through the regulator body and are fluidly separable by the valve seat and the movable valve member. A diaphragm divides the cavity into a first portion having the valve seat and the movable valve member positioned therein and a second portion has fluidly isolated from the first portion. A biasing means is connected to the poppet and is positioned within the second portion of the cavity for moving the movable valve member.

Another embodiment includes a fluid regulator having a valve body constructed to be pulled closed. The fluid regulator includes a diaphragm disposed in a housing and configured to divide an interior of the housing into a first region and a second region. A fluid inlet and a fluid outlet are connected to the first region. A valve seat is disposed in the first region between the fluid inlet and the fluid outlet. A valve body extends through the diaphragm and is constructed to sealingly engage the valve seat to isolate the fluid inlet and the fluid outlet when the valve body is engaged with the valve seat. A spring is connected to the valve seat and configured to pull the valve body into engagement with the valve seat.

A further embodiment includes a regulator having a valve stem that directly engages a valve seat. The regulator has a body that encloses a chamber having a fluid inlet and a fluid outlet. A gasket fluidly separates a portion of the chamber from a fluid path between the fluid inlet and the fluid outlet. A valve seat is disposed in the fluid path and a valve stem extends through the gasket and is constructed to directly engage the valve seat to selectively isolate an inlet side of the fluid path from an outlet side of the fluid path.

As one skilled in the art will fully appreciate, the heretofore description of a fluid regulator has applications beyond the disclosed paint sprayer application. It is appreciated that the present invention is equivalently applicable with any device requiring fluid regulation with separate fluid flows. Description of a paint sprayer illustrates just one embodiment in which the present invention may be implemented. The present invention has been described in terms of the preferred embodiment, and it is recognized that equivalents, alternatives, and modifications, aside from those expressly stated, are possible and within the scope of the appending claims.

What is claimed is:

1. A fluid regulator comprising:
a regulator body defining a cavity;
a valve seat positioned in the cavity;
a movable valve member having a poppet with a ball portion formed at an end thereof;
an inlet port and an outlet port formed through the regulator body and fluidly separable by the valve seat and the movable valve member;
a diaphragm dividing the cavity into a first portion and a second portion, the first portion having the valve seat and the movable valve member and the second portion fluidly isolated from the first portion; and
biasing means connected to the poppet and positioned within the second portion of the cavity for moving the movable valve member.

2. The fluid regulator of claim 1 further comprising a threaded portion formed on an exterior surface of the regulator body.

3. The fluid regulator of claim 2 wherein the threaded portion is constructed to engage a paint spray gun.

4. The fluid regulator of claim 1 wherein the body has a first section and a second section that are constructed to sealingly engage a perimeter of the diaphragm.

5. The fluid regulator of claim 1 wherein the inlet port is threadingly connected to the regulator body and secures the valve seat to the regulator body.

6. The fluid regulator of claim 1 wherein the biasing means is at least one of a spring, a magnet, and a belvil spring.

7. A fluid regulator comprising:
a housing;
a diaphragm disposed in the housing and configured to divide an interior of the housing into a first region and a second region;
a fluid inlet and a fluid outlet connected to one of the first region and the second region;
a valve seat disposed in the first region between the fluid inlet and the fluid outlet;
a valve body extending through the diaphragm and constructed to sealingly engage the valve seat to isolate the fluid inlet and the fluid outlet when the valve body is engaged with the valve seat; and
a spring connected to the valve seat and configured to pull the valve body into engagement with the valve seat.

8. The fluid regulator of claim 7 wherein a path between the fluid inlet and the fluid outlet is free of a spring.

9. The fluid regulator of claim 7 further comprising a plurality of threads formed on an exterior surface of the housing.

10. The fluid regulator of claim 9 wherein the plurality of threads are constructed to secure the fluid regulator to a paint sprayer.

11. The fluid regulator of claim 7 wherein the valve body further comprises a flange and the spring is disposed between the flange and a portion of the housing.

12. The fluid regulator of claim 11 wherein the flange is threadably connected to the valve body.

13. The fluid regulator of claim 7 attached to a paint spray gun such that paint flows through the regulator and the spring is isolated from the paint.

14. The fluid regular of claim 7 wherein a portion of the valve body is constructed to pass through valve seat in a single direction.

15. A regulator comprising:
a body enclosing a chamber and having a fluid inlet and a fluid outlet;
a gasket fluidly separating a portion of the chamber from a fluid path between the fluid inlet and the fluid outlet;
a valve seat disposed in the fluid path; and
a valve stem extending through the gasket and constructed to directly engage the valve seat to selectively isolate an inlet side of the fluid path from an outlet side of the fluid path.

16. The regulator of claim 15 further comprising a ball portion formed proximate an end of the valve stem, the ball portion having an arcuate shape constructed to snuggly engage the valve seat.

17. The regulator of claim 15 further comprising a spring attached to the valve stem and constructed to pull the valve stem into engagement with the valve seat.

18. The regulator of claim 15 further comprising a spring connected to the valve stem on a side of the gasket generally opposite the fluid path.

19. The regulator of claim 15 further comprising an air inlet and an air outlet formed in the body and on a side of the gasket generally opposite the fluid path.

20. The regulator of claim 15 further comprising a belvil washer attached to the valve stem and disposed between a portion of the body and a flange of the valve stem.
